(19) United States
(12) Patent Application Publication
(10) Pub. No.: US 2021/0283501 A1
(43) Pub. Date: Sep. 16, 2021

(54) Scoring control system in real time in a motorcycle trial competition

(71) Applicant: Ismael Lobato, Barcelona (ES)

(72) Inventor: Ismael Lobato, Barcelona (ES)

(21) Appl. No.: 16/817,654

(22) Filed: Mar. 13, 2020

(51) Int. Cl. A63F 13/46; A63F 13/803

(52) U.S. Cl. CPC A63F 13/46; H04B 1/3827; A63F 13/803

(57) ABSTRACT

Scoring control system in a motorcycle trial competition comprising a race course divided in sections, each section comprising a transmitter at the section entry, a transmitter at the section exit, at least one motorcycle rider (2) provided with a personal electronic sensor (4) detectable by other devices (6), at least one motorcycle (1), a chief observer of the section provided with portable control device (6) such as a CPU, tablet or laptop with an internal rechargeable battery to supply power, an organisation provided with its own devices for the organization of the competition, computers, CPUs, tablets, and external information panels (9) where the chief observer can obtain the most important information for the competition in real time and then send it to the organization to be displayed at external information panels

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The field of the invention corresponds to the auxiliary industry of electronic control and positioning devices.

### Description of Related Art

At present, the data capturing system of each rider as he passes through the sections is completely manual.

Depending on the trial and the organiser, there are various ways to keep score, either with scorecards for each rider or else with score sheets, where the section judge has a table with a sheet and notes the scores down on it.

When a scorecard is delivered to a rider, he will carry it with him during the entire competition. At the end of each section, the judge notes on this card all the data related to the section.

Upon ending the route, the rider delivers the card to the control table, where another judge takes it and manually enters each rider's card into a computer.

When all the scores of the scorecards or sheets of the riders have been entered, the classifications of the trial are made, taking into account the participants' number of points and times.

There are other requirements during a motorcycle trial that are not now covered, but electronic systems could be of great utility in make things easier for the Judge or for informing the public.

The inventor knows of the existence of electronic devices of identification, and the use of a CPU is not new for compilation work, but the union of all these elements, the interrelation between them and their use in solving the technical problem in real time, the knowledge of the scores of the riders, for the rider himself as well as for his team, for the organisation and for the attending public are new and constitute an inventive step.

The inventor does not know of the existence of devices referring to this with the technical advantages and characteristics of the invention recommended herein.

### BRIEF SUMMARY OF THE INVENTION

This invention, as expressed in the title of this descriptive report, refers to a scoring control system in real time in a motorcycle trial competition in such a way that the rider, chief observer of the section, organisation and spectators have the scores of all the riders in real time.

The problem up to now was that the organisation only knew the information of each chief observer at the end of the trial when the competitors turned in the cards with the scores to the organisation and there the scores were added up and the results were presented.

Neither the riders nor the rider's teams knew what were the scores of the competitors in order to be able to establish the strategies to follow.

### BRIEF DESCRIPTION OF THE DRAWINGS

To complement the description that is being made and with the aim of providing a better understanding of the characteristics of the invention, this descriptive report is accompanied by a page of plans. as an integral part thereof, in which with identical references the same elements are identified and where the following has been represented as an example but not limited to this:

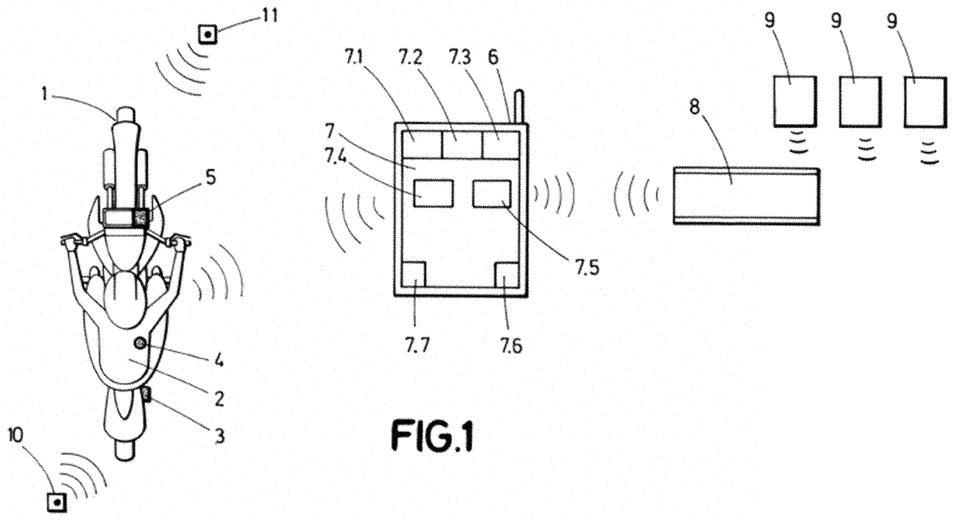

FIG. 1—Diagram of the control system.
In this FIGURE the same elements are identified with identical numeration:
   (1)—motorcycle,
   (2)—rider,
   (3)—motorcycle sensor,
   (4)—rider's sensor,
   (5)—motorcycle screen,
   (6)—observer's device,
   (7)—screen of the observer's device,
   (7.1)—identification window of the motorcycle,
   (7.2)—identification window of the rider,
   (7.3)—identification window of the section number,
   (7.4)—touch numerical window,
   (7.5)—identification window of failure
   (7.6)—deletion/edition button,
   (7.7)—button to send data,
   (7.8)—button to pass to a new screen
   (7.9)—chronometer with time of entry into and exit from the section
   (8)—CPU of the organisation,
   (9)—external information panels,
   (10)—transmitter of the section entry,
   (11)—transmitter of the section exit

### DETAILED DESCRIPTION OF THE INVENTION

The scoring control system in a motorcycle trial competition is composed of several independent but interrelated basic elements which are: the rider, the motorcycle, the chief observer of the section, and the organisation that brings all the results together.

And the interaction between them is the following:

The rider will carry a chip that identifies him and that will be detectable by the chief observer of the section.

The chief observer has a portable control device, such as a CPU, Tablet or similar with its internal rechargeable battery to supply power and on whose touch screen at least the following elements are observed:
Identification window of the motorcycle, by reading the code of the motorcycle's sensor.
Identification window of the rider, by reading the code of the rider's sensor.
Numerical identification window of the section, by reading the transmitter at the entrance to the section or manually entering the section number.
Touch numerical window with counter of the number of times the rider touches the ground (on this screen all the possible scores that a rider could get are shown).
Button to erase data,
Button to send data,
Button to go to a new screen,
Chronometer with the time of entry to and exit from the section.

By pressing the send button, the observer sends to the CPU of the organisation the data of his section. The CPU of the organisation receives the data from all the sections in real time, organises and systematises them to make a list by sections, riders and total results that are sent to the external information panels in order for the public to follow them in real time.

This information can also be received by the riders' teams, the commissioners, and all those enthusiasts that are registered in the organisation and who are granted authorisation and a password for connection with the organisation.

### Description of the Preferred Embodiment

The scoring control system in a motorcycle trial competition is composed by several independent, interrelated elements.

The four basic elements of the system are the rider (2), the motorcycle (1), the chief observer of the section, and the organisation which brings all the results together. And the interaction among them is the following:

Besides the usual elements, the motorcycle (1) is equipped with a specific sensor (3) with its RFID-type identification code and a screen (5) with the information in real time, corresponding to the section in which the rider is located and at the end of the section he will see the time used and the score the observer has given him.

He also has the possibility of seeing the previous accumulated scores. There is a possibility of reviewing the scores of other sections already passed.

This information includes at least the indication of the section number, information received through a transmitter of the entry to the section (10), score of the section as it is producing in interaction with the chief observer's device (6), total score and chronometer with time used in it measured according to the entry and exit transmitters from the section (10) and (11) and acoustic signal notifying the section's time limit.

The rider is provided with an personal electronic sensor (4) which is detectable by the chief observer's device (6).

The chief observer has a portable control device such as a CPU, Tablet or similar with its internal rechargeable battery to supply power and on whose touch screen at least the following elements are observed:
(7.1)—Identification window of the motorcycle, by reading the code of the motorcycle's sensor (3).
(7.2)—Identification window of the rider, by reading the code of the rider's sensor (4).
(7.3)—Numerical identification window of the section, by reading the transmitter at the entrance to the section (10)
(7.4)—Touch numerical window with counter of the number of times the rider touches the ground.
(7.5)—Touch window of indication of failure, that is, section not passed.
(7.6)—Button to erase data/edition,
(7.7)—Button to send data,
(7.8)—Button to go to a new screen.
(7.9)—Chronometer with the time of entry in and exit from the section

By pressing the send button (7.7), the observer sends to the CPU of the organisation (8) the data of his section. The CPU of the organisation (8) receives the data from all the sections in real time, organises and systematises them to make a list by sections, riders and total results that are sent to the external information panels (9) in order for the public to follow them in real time.

Having described sufficiently the nature of the invention, as well as the way to carry it out, it must be observed that the previously indicated devices represented in the attached drawings are susceptible to modifications of details while not altering their basic principles, established in the above paragraphs and summarised in the following claims.

1. Scoring control system in a motorcycle trial competition comprising
a race course divided in sections, each section comprising
a transmitter at the section entry,
a transmitter at the section exit
at least one motorcycle rider (2) provided with a personal electronic sensor (4) detectable by other devices (6) at least one motorcycle (1),
a chief observer of the section provided with portable control device (6) such as a CPU, tablet or laptop with an internal rechargeable battery to supply power an organisation provided with its own devices for the organization of the competition, computers, CPUs, tablets.
external information panels (9)

2. The system according to claim 1 wherein the motorcycle (1) comprises,
a specific sensor (3) with its RFID-type identification and a screen (5) that provides information in real time, namely
a location corresponding to the section of the race course in which the motorcycle (1) is at
an indication of the time used in each section, measured according to the transmitters placed at the entry and exit of each section (10) and (11) and an acoustic signal of the section's time limit.

3. The system according to claim 1 wherein in the portable control device (6) such as a CPU, tablet or laptop provided to the chief observer the following elements can be seen:
(7.1)—Identification window of the motorcycle, by reading the code of the motorcycle's sensor (3).
(7.2)—Identification window of the rider, by reading the code of the rider's sensor (4).
(7.3)—Numerical identification window of the section, by reading the transmitter at the entrance to the section (10).
(7.4)—Touch numerical window with counter of the number of times the rider touches the ground.
(7.5)—Touch window of indication of failure.
(7.6)—Button to erase data/edition.
(7.7)—Button to send data.
(7.8)—Button to go to a new screen.
(7.9)—Chronometer with the time of entry in and exit from the section.

4. The system according to claim 3 wherein the chief observer by means of the data send button (7.7) sends to the organisation's devices (8) the data of his section.

5. The system according to claim 4 wherein the organisation's devices (8) receives the data from all the sections in real time, organises and sytematises them to make a list by sections, riders and total results which are sent to the external information panels (9) in order for the public to see them in real time.
